(19) United States
(12) Patent Application Publication
(10) Pub. No.: US 2026/0276457 A1
(43) Pub. Date: Sep. 17, 2026

(54) PRESSURE SENSOR

(71) Applicant: Sumitomo Riko Company Limited, Aichi (JP)

(72) Inventors: Mitsutoshi Agata, Aichi (JP); Koichi Hasegawa, Aichi (JP)

(73) Assignee: Sumitomo Riko Company Limited, Aichi (JP)

(21) Appl. No.: 19/667,662

(22) Filed: May 5, 2026

Related U.S. Application Data
(63) Continuation of application No. PCT/JP2025/008869, filed on Mar. 10, 2025.

(30) Foreign Application Priority Data
Mar. 29, 2024 (JP) 2024-055888

(51) Int. Cl. G01L 1/14

(52) U.S. Cl. CPC G01L 1/142

(57) ABSTRACT

A pressure sensor includes an insulator sheet body, a first detection electrode, a second detection electrode, a first insulator sheet, and a first shield electrode. A thickness of the first insulator sheet is equal to or less than a thickness of the insulator sheet body. The first shield electrode is disposed to overlap the first detection electrode when viewed from a thickness direction of the first shield electrode, has an outer shape including an outer shape of the first detection electrode, and includes a plurality of first openings penetrating in a thickness direction of the first shield electrode.

### CROSS-REFERENCE TO RELATED APPLICATION

The present application is a continuation of international PCT application serial no. PCT/JP2025/008869, filed on Mar. 10, 2025, and is related to and claims priority from Japanese patent application no. 2024-055888, filed on Mar. 29, 2024. The entire contents of the aforementioned application are hereby incorporated by reference herein.

### BACKGROUND

### Technical Field

The disclosure relates to a pressure sensor.

### Related Art

Conventionally, a pressure sensor described in Patent Document 1 (International Publication No. WO 2019/116919) is known as a pressure sensor that is arranged in a seat of a vehicle such as an automobile and detects biometric information of a seated person. This pressure sensor is arranged in a seat cushion of the seat and detects biometric information such as respiration and heartbeat of a person seated in the seat.

In the above pressure sensor, an insulator sheet made of nonwoven fabric is arranged between a pair of detection electrodes made of conductive cloth having conductivity. In response to a person sitting in the seat, pressure is applied to the pressure sensor by, for example, respiration or heartbeat of the seated person. Then, the insulator sheet arranged between the pair of detection electrodes is compressed, and the distance between the pair of detection electrodes changes. This causes the capacitance between the pair of detection electrodes to change. By detecting this change in capacitance, biometric information of the seated person is detected.

Various electrical equipment may be arranged around the seat. For example, in a vehicle, numerous electrical equipment exists around the seat. In such a case, in order to improve the detection accuracy of the pressure sensor, it is desirable to electromagnetically shield noise generated from the electrical equipment. Thus, it is conceivable to arrange a shield electrode on the outer side of the detection electrode. In this case, an insulating interposition is arranged between the detection electrode and the shield electrode. As a result, so-called parasitic capacity occurs between the detection electrode and the shield electrode. Due to the influence of the parasitic capacity, the detection sensitivity by the detection electrode may decrease.

In order to reduce the parasitic capacity, it is conceivable to increase the distance between the detection electrode and the shield electrode by increasing the thickness of the insulating interposition. In response to the insulating interposition being formed of a relatively hard material, increasing the thickness of the insulating interposition may reduce the seating comfort of a seated person seated in the seat. On the other hand, in response to the insulating interposition being formed of a relatively soft material, pressure corresponding to the biometric information applied from the seated person is absorbed by the insulating interposition, and the detection sensitivity of the pressure sensor may decrease.

Further, besides the seat, a similar problem arises in response to a pressure sensor being arranged in bedding or the like to acquire biometric information of a user.

One aspect of the disclosure is to provide a pressure sensor that suppresses giving discomfort to a user of a seat or bedding and has improved detection sensitivity. Further, another aspect of the disclosure is to provide a pressure sensor that may achieve cost reduction with a simple configuration.

### SUMMARY

One aspect of the disclosure is a pressure sensor including an insulator sheet body, a first detection electrode disposed on a first surface side of the insulator sheet body, a second detection electrode disposed on a second surface side of the insulator sheet body and disposed to overlap the first detection electrode, a first insulator sheet disposed on an outer surface side of the first detection electrode, and a first shield electrode disposed on an outer surface side of the first insulator sheet and electromagnetically shielding the first detection electrode, where a thickness of the first insulator sheet is equal to or less than a thickness of the insulator sheet body, the first shield electrode is disposed to overlap the first detection electrode when viewed from a thickness direction of the first shield electrode, has an outer shape including an outer shape of the first detection electrode, and includes a plurality of first openings penetrating in a thickness direction of the first shield electrode.

Another aspect of the disclosure is a pressure sensor including an insulator sheet body, a first electrode unit disposed on a first surface side of the insulator sheet body, disposed non-adhered to the insulator sheet body, and configured as a separate body from the insulator sheet body, and a second detection electrode disposed on a second surface side of the insulator sheet body, disposed non-adhered to the insulator sheet body, and disposed to overlap the first electrode unit, where the first electrode unit includes:

a first insulator sheet,

a first detection electrode, adhered to an inner surface of the first insulator sheet, and

a first shield electrode adhered to an outer surface of the first insulator sheet and electromagnetically shielding the first detection electrode.

### BRIEF DESCRIPTION OF THE DRAWINGS

FIG. 1 is a diagram showing a configuration of a state estimation system of a user including a pressure sensor in an embodiment.

FIG. 2 is a perspective view of the pressure sensor as viewed from above.

FIG. 3 is a perspective view of the pressure sensor as viewed from below.

FIG. 4 is an exploded perspective view of the pressure sensor with the protective film removed, as viewed from above.

FIG. 5 is an exploded perspective view of the pressure sensor with the protective film removed, as viewed from below.

FIG. 6 is a cross-sectional view of the pressure sensor.

FIG. 7 is a cross-sectional view showing an exploded state of an insulator sheet, a first electrode unit, and a second electrode unit constituting the pressure sensor.

FIG. 8 is a plan view of the first electrode unit with the protective film removed, as viewed from above (outer surface side). In FIG. 8, the first shield electrode, the first main wiring shield electrode, and the first sub-wiring shield electrode are shown only by their outer shapes (contour lines).

FIG. 9 is a plan view of the second electrode unit with the protective film removed, as viewed from above (inner surface side). In FIG. 9, the second shield electrode, the second main wiring shield electrode, and the second sub-wiring shield electrode are shown only by their outer shapes (contour lines).

FIG. 10 is a perspective view showing a first electrode unit (excluding the protective film) constituting the pressure sensor in a modification example.

### DESCRIPTION OF EMBODIMENTS

According to one aspect of the disclosure, since the thickness of the first insulator sheet is equal to or less than the thickness of the insulator sheet body, the thickness of the entire pressure sensor may be reduced. This may improve the seating comfort of a seated person sitting on a seat on which the pressure sensor is arranged. Further, the sleeping comfort of a user utilizing bedding on which the pressure sensor is arranged may be improved. In this way, it is possible to suppress causing discomfort to users of seats, bedding, and the like on which the pressure sensor is arranged.

Furthermore, the pressure sensor may reduce the influence of noise that the first detection electrode receives from the outside by including the first shield electrode. Furthermore, by providing the first shield electrode with a plurality of first openings, the area where the first detection electrode and the first shield electrode face each other may be reduced. As a result, the parasitic capacity generated between the first detection electrode and the first shield electrode may be reduced. This may improve the detection sensitivity of the pressure sensor.

As described above, according to one aspect of the disclosure, it is possible to provide a pressure sensor with improved detection sensitivity while suppressing causing discomfort to users of seats and bedding.

According to another aspect of the disclosure, the first insulator sheet, the first detection electrode, and the first shield electrode constitute a first electrode unit. By having such a simple configuration, manufacturing becomes easy, and cost reduction may be achieved. Furthermore, the distance between the first detection electrode and the first shield electrode may be maintained in a stable state. As a result, fluctuation of the parasitic capacity between the first detection electrode and the first shield electrode may be suppressed. Thus, the detection sensitivity of the pressure sensor may be improved.

As described above, according to another aspect of the disclosure, it is possible to provide a pressure sensor that may achieve cost reduction with a simple configuration.

### Embodiment

### 1. Overview of user state estimation system 1

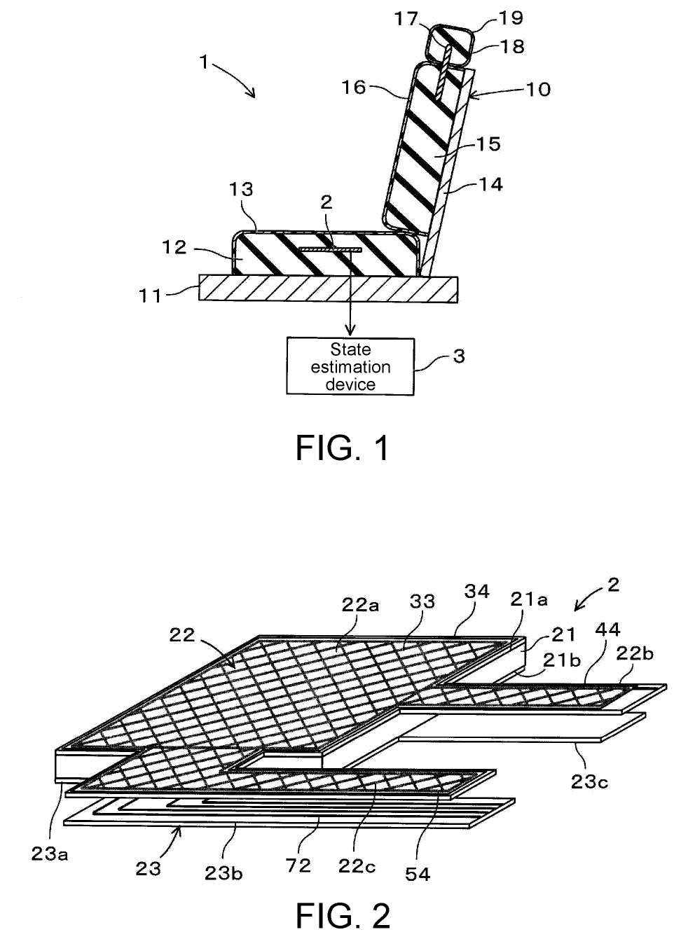

An overview of the user state estimation system 1 in the present embodiment is described with reference to FIG. 1. The user state estimation system 1 is configured to estimate a state of a seated person seated on a seat 10 of a vehicle or a seat 10 of furniture. However, the user state estimation system 1 may target not only a seated person on the seat 10, but also a seated person on a floor cushion, and furthermore, may target a user lying on bedding such as a bed or futon.

The state of the user, which is the estimation target, includes at least one biometric information selected from the user's heartbeat information, respiration information, and the like. Furthermore, the state of the user, which is the estimation target, may include a seated posture (sitting posture) of a person seated on the seat 10 or a floor cushion, and a sleeping posture (lying posture) of a person sleeping on bedding. In the present embodiment, an example is given in which the state of the user, which is the estimation target, includes heartbeat information, respiration information, and a seated posture (sitting posture) of a person seated on the seat 10. The seated posture includes at least one of the seated posture itself representing the seating position and the like, and a change in the seated posture.

### 2. Configuration of seat 10

As described above, in the present embodiment, the user state estimation system 1 estimates the biometric information and the seated posture of a person seated on the seat 10. Thus, the configuration of the seat 10 is described with reference to FIG. 1.

The seat 10 includes a seat surface frame 11, a seat cushion 12, a seat surface skin material 13, a back frame 14, a back cushion 15, a back surface skin material 16, a headrest frame 17, a headrest cushion 18, and a headrest skin material 19. Here, in the seat 10, the seat cushion 12 and the seat surface skin material 13 may be configured to be fixed to the seat surface frame 11, or may be configured to be detachably placed on the seat surface frame 11 like a floor cushion.

### 3. Basic configuration of user state estimation system 1

The basic configuration of the user state estimation system 1 is described with reference to FIG. 1. The state estimation system 1 includes a pressure sensor 2 and a state estimation device 3.

In the present embodiment, the pressure sensor 2 is disposed within the seat cushion 12 of the seat 10. For example, the pressure sensor 2 is disposed at an intermediate position in an up-down direction of the seat cushion 12 and is disposed sandwiched between upper and lower cushions. The pressure sensor 2 outputs a signal corresponding to pressure input through the seat cushion 12. The pressure sensor 2 may be disposed in the back cushion 15 instead of the seat cushion 12. Further, the pressure sensor 2 may be disposed within a floor cushion.

The pressure sensor 2 is configured so as not to give a user seated on the seat 10 discomfort associated with the presence of the pressure sensor 2. For example, the pressure sensor 2 is formed in a sheet shape (film shape) and has flexibility. The pressure sensor 2 may be configured to be stretchable in the planar direction, or may be configured to be non-stretchable.

The pressure sensor 2 is configured to detect a signal used for estimating biometric information of a user. For example, the pressure sensor 2 is configured to detect pressure transmitted through the seat cushion 12 due to pulsation of an artery in the thigh portion of the user. Here, the pulsation of the artery in the thigh portion includes movement corresponding to the heartbeat and the respiration, which are biometric information. Thus, the pressure sensor 2 is configured to detect the pulsation of the artery in the thigh portion as a signal used for estimating biometric information.

Furthermore, in the present embodiment, the pressure sensor 2 is configured to detect a signal used for estimating a seated posture of a user. The seating position of the user or a change in the seated posture of the user corresponds to a position of the thigh portion of the user or a change in a position of the thigh portion. Thus, the pressure sensor 2 is configured to detect the position of the thigh portion of the user or a change in the position of the thigh portion as a signal used for estimating the posture of the user.

In the case of detecting the biometric information or a lying posture of a user of bedding, the pressure sensor 2 may be disposed within bedding such as a mattress or a futon. Further, the pressure sensor 2 may also be disposed within a sheet laid on the bedding. Further, the pressure sensor 2 may also be disposed between stacked bedding.

The state estimation device 3 is configured to estimate a state of a user seated on the seat 10 by performing arithmetic processing based on a signal output by the pressure sensor 2. The state estimation device 3 may be disposed within the seat cushion 12, or may be disposed outside the seat cushion 12.

Specifically, the state estimation device 3 applies a voltage for pressure detection to the pressure sensor 2. Furthermore, the state estimation device 3 detects a voltage corresponding to the capacitance detected by the pressure sensor 2 in response to a detection voltage being applied to the pressure sensor 2. Then, the state estimation device 3 estimates a state of the user by performing arithmetic processing based on a signal output from the pressure sensor 2. The state of the user to be estimated is, as described above, the biometric information of the user, the seated posture of the user, and the like.

In the case where the state estimation system 1 of the user targets a user of bedding, the state estimation device 3 estimates the biometric information or the lying posture of the user of the bedding by performing arithmetic processing based on a signal output from the pressure sensor 2 disposed in the bedding.

### 4. Basic configuration of pressure sensor 2

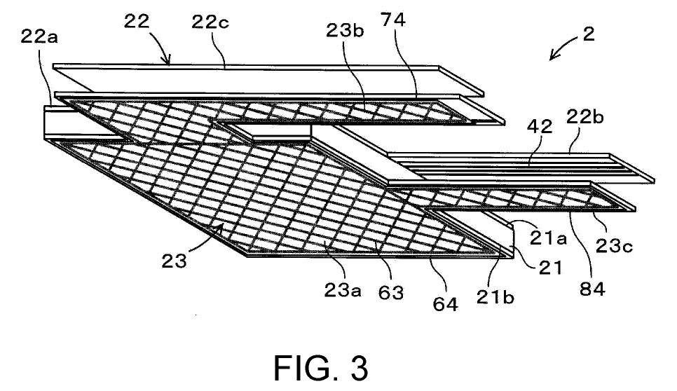

A basic configuration of the pressure sensor 2 will be described with reference to FIGS. 2 and 3. The pressure sensor 2 is formed in a sheet shape and constitutes a capacitive sensor. The pressure sensor 2 is configured to include an insulator sheet body 21, a first electrode unit 22, and a second electrode unit 23.

The insulator sheet body 21 constitutes a dielectric layer as a capacitive sensor. The insulator sheet body 21 is formed of an elastically deformable material. For example, the insulator sheet body 21 is formed of an insulating elastomer or rubber. Accordingly, the insulator sheet body 21 is configured to undergo compression deformation in the case where the pressure sensor 2 receives a compressive force in a surface normal direction. The insulator sheet body 21 has a predetermined thickness so as to be capable of compression deformation. The thickness of the insulator sheet body 21 is set to, for example, 0.1 mm to 5 mm. For example, in FIG. 2 and FIG. 3, the outer shape of the insulator sheet body 21 is, for example, rectangular, but may be any shape.

The first electrode unit 22 is configured to include one electrode of the capacitive sensor. The first electrode unit 22 is formed in a sheet shape (film shape). The first electrode unit 22 is disposed on a first surface 21a side of the insulator sheet body 21 (upper side in FIGS. 2 and 3). In the present embodiment, the first electrode unit 22 is disposed in contact with the first surface 21a of the insulator sheet body 21. However, the first electrode unit 22 is disposed in a non-adhesive manner to the insulator sheet body 21. That is, in the present embodiment, the first electrode unit 22 is configured as a separate body from the insulator sheet body 21.

The first electrode unit 22 includes a first sensor electrode portion 22a, a first wiring portion 22b, and a first dummy wiring portion 22c. The first sensor electrode portion 22a is located at a part corresponding to the insulator sheet body 21. In the present embodiment, the first sensor electrode portion 22a has the same outer shape as the insulator sheet body 21, but may have a different shape. The first sensor electrode portion 22a is configured to include one electrode of the capacitive sensor. The first sensor electrode portion 22a is disposed in contact with the first surface 21a of the insulator sheet body 21.

The first wiring portion 22b is formed in an elongated sheet shape. The first wiring portion 22b has a function of electrically connecting the state estimation device 3 and the first sensor electrode portion 22a. The first wiring portion 22b extends in a planar direction of the first sensor electrode portion 22a from a part of a side edge (outer peripheral edge) of the first sensor electrode portion 22a. In detail, a portion near one end of the first wiring portion 22b is connected to one side of the rectangle of the first sensor electrode portion 22a.

The first dummy wiring portion 22c is formed in an elongated sheet shape. The first dummy wiring portion 22c is formed slightly shorter than a second wiring portion 23b described later. The first dummy wiring portion 22c does not have a function as wiring, and is provided to have a shielding function. The first dummy wiring portion 22c extends in a planar direction of the first sensor electrode portion 22a from a part of a side edge (outer peripheral edge) of the first sensor electrode portion 22a. In detail, a portion near one end of the first dummy wiring portion 22c is connected to another one side of the rectangle of the first sensor electrode portion 22a. In the present embodiment, the first wiring portion 22b and the first dummy wiring portion 22c are respectively connected to adjacent sides of the rectangle of the first sensor electrode portion 22a.

The second electrode unit 23 is configured to include the other electrode of the capacitive sensor. The second electrode unit 23 is formed in a sheet shape (film shape). The second electrode unit 23 is disposed on a second surface 21b side of the insulator sheet body 21 (lower side in FIGS. 2 and 3). In the present embodiment, the second electrode unit 23 is disposed in contact with the second surface 21b of the insulator sheet body 21. However, the second electrode unit 23 is disposed in a non-adhesive manner to the insulator sheet body 21. That is, in the present embodiment, the second electrode unit 23 is configured as a separate body from the insulator sheet body 21.

The second electrode unit 23 includes a second sensor electrode portion 23a, a second wiring portion 23b, and a second dummy wiring portion 23c. The second sensor electrode portion 23a is located at a part corresponding to the insulator sheet body 21. In the present embodiment, the second sensor electrode portion 23a has the same outer shape as the insulator sheet body 21, but may have a different shape. Then, the second sensor electrode portion 23a is configured to include the other electrode of the capacitive sensor. The second sensor electrode portion 23a is disposed in contact with the second surface 21b of the insulator sheet body 21.

The second wiring portion 23b is formed in an elongated sheet shape. The second wiring portion 23b has a function of electrically connecting the state estimation device 3 and the second sensor electrode portion 23a. The second wiring portion 23b extends in a planar direction of the second sensor electrode portion 23a from a part of a side edge (outer peripheral edge) of the second sensor electrode portion 23a. In detail, a portion near one end of the second wiring portion 23b is connected to one side of the rectangle of the second sensor electrode portion 23a.

The second dummy wiring portion 23c is formed in an elongated sheet shape. The second dummy wiring portion 23c is formed slightly shorter than the first wiring portion 22b. The second dummy wiring portion 23c does not have a function as wiring, and is provided to have a shielding function. The second dummy wiring portion 23c extends in a planar direction of the second sensor electrode portion 23a from a part of a side edge (outer peripheral edge) of the second sensor electrode portion 23a. In detail, a portion near one end of the second dummy wiring portion 23c is connected to another one side of the rectangle of the second sensor electrode portion 23a. In the present embodiment, the second wiring portion 23b and the second dummy wiring portion 23c are respectively connected to adjacent sides of the rectangle of the second sensor electrode portion 23a.

The second electrode unit 23 is disposed so as to overlap the first electrode unit 22. That is, the first electrode unit 22 and the second electrode unit 23 are disposed so as to overlap when viewed from the thickness direction of the insulator sheet body 21. In the present embodiment, an outer shape of the second electrode unit 23 is formed to be the same as an outer shape of the first electrode unit 22. Thus, the first electrode unit 22 and the second electrode unit 23 are disposed so as to overlap over the entire region.

The first sensor electrode portion 22a of the first electrode unit 22 and the second sensor electrode portion 23a of the second electrode unit 23 face each other with the insulator sheet body 21 interposed therebetween. The first wiring portion 22b of the first electrode unit 22 and the second dummy wiring portion 23c of the second electrode unit 23 directly face each other without the insulator sheet body 21 interposed therebetween. The first wiring portion 22b and the second dummy wiring portion 23c have a portion that is in direct contact. The first dummy wiring portion 22c of the first electrode unit 22 and the second wiring portion 23b of the second electrode unit 23 directly face each other without the insulator sheet body 21 interposed therebetween. The first dummy wiring portion 22c and the second wiring portion 23b have a portion that is in direct contact.

However, an insulator sheet similar to the insulator sheet body 21 may be disposed between the first wiring portion 22b and the second dummy wiring portion 23c. Similarly, an insulator sheet similar to the insulator sheet body 21 may be disposed between the first dummy wiring portion 22c and the second wiring portion 23b.

### 5. Details of first electrode unit 22 and second electrode unit 23

### 5-1. Details of first electrode unit 22

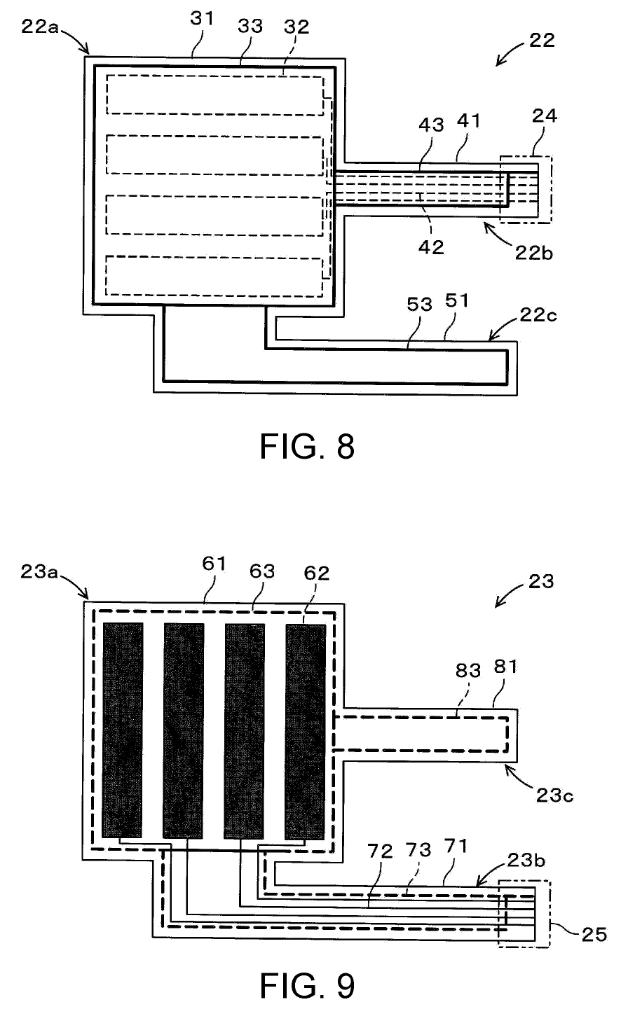

Details of the first electrode unit 22, which is a component of the pressure sensor 2, will be described with reference to FIGS. 2 to 8. As described above, the first electrode unit 22 includes the first sensor electrode portion 22a, the first wiring portion 22b, and the first dummy wiring portion 22c.

The first sensor electrode portion 22a includes a first insulator sheet 31, a first detection electrode 32, a first shield electrode 33, and a first sensor protective film 34 (shown in FIGS. 2 and 7).

The first insulator sheet 31 is, for example, a resin sheet. As shown in FIGS. 2 to 7, the first insulator sheet 31 is disposed to face the first surface 21a of the insulator sheet body 21 and has an outer shape similar to that of the insulator sheet body 21. In the present embodiment, the first insulator sheet 31 is formed in a rectangular shape similar to that of the insulator sheet body 21. The thickness of the first insulator sheet 31 is set to be equal to or less than the thickness of the insulator sheet body 21. In particular, the thickness of the first insulator sheet 31 may be set to be thinner than the thickness of the insulator sheet body 21. The thickness of the first insulator sheet 31 is set, for example, in a range of 10 μm to 2 mm.

The first insulator sheet 31 is formed of a material having a Young's modulus greater than the Young's modulus of the insulator sheet body 21. For example, the first insulator sheet 31 is formed of polyethylene terephthalate (PET), polyethylene naphthalate (PEN), polyimide (PI), or the like. Furthermore, as described above, the thickness of the first insulator sheet 31 is set to be thinner than the thickness of the insulator sheet body 21. By setting in this manner, the first insulator sheet 31 may be made less likely to undergo compression deformation relative to the insulator sheet body 21. Thus, in response to the pressure sensor 2 receiving pressure, the thickness of the first insulator sheet 31 may be made to hardly change.

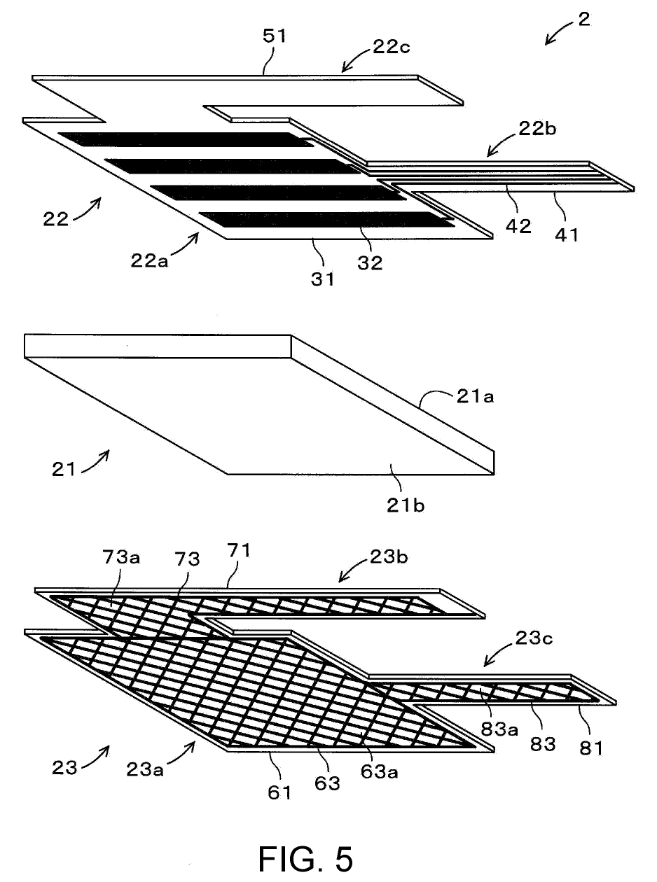

The first detection electrode 32 is disposed on the inner surface side of the first insulator sheet 31, as shown in FIGS. 5 to 8. Thus, the first detection electrode 32 is disposed on the first surface 21a side of the insulator sheet body 21, and the first insulator sheet 31 is disposed on the outer surface side of the first detection electrode 32. In the present embodiment, the first detection electrode 32 is disposed in a non-adhesive manner to the insulator sheet body 21.

In the present embodiment, the first detection electrode 32 is adhered to the inner surface of the first insulator sheet 31. The first detection electrode 32 is formed by printing a conductive material on the inner surface of the first insulator sheet 31. Thus, the first detection electrode 32 is a printed formation adhered to the inner surface of the first insulator sheet 31. The first detection electrode 32 may be made of any material as long as it is a conductive material. For example, silver, copper, carbon, or the like may be applied to the first detection electrode 32. The thickness of the first detection electrode 32 is set, for example, in a range of 1 μm to 100 μm.

The first detection electrode 32 is formed into a plurality of strip electrodes parallel to one side of the rectangle of the first insulator sheet 31, as shown in FIGS. 5 to 8. In the present embodiment, the first detection electrode 32 has four strip electrodes, but may be any number of strip electrodes. The first detection electrode 32 may be, for example, a plurality of electrodes arranged in a matrix of a plurality of rows × a plurality of columns. For example, in response to the first detection electrode 32 being arranged in 4 rows × 4 columns, there are 16 electrodes.

The first shield electrode 33 is configured to electromagnetically shield the first detection electrode 32. The first shield electrode 33 is disposed on the outer surface side of the first insulator sheet 31, as shown in FIGS. 2, 4, and 6 to 8. In the present embodiment, the first shield electrode 33 is adhered to the outer surface of the first insulator sheet 31. In the present embodiment, the first shield electrode 33 is formed by printing a conductive material on the outer surface of the first insulator sheet 31. Thus, the first shield electrode 33 is a printed formation adhered to the outer surface of the first insulator sheet 31. The first shield electrode 33 may be made of any material as long as it is a conductive material. For example, silver, copper, carbon, or the like may be applied to the first shield electrode 33. However, in response to silver or copper being used, it is preferable to coat with carbon or the like to prevent oxidation. The thickness of the first shield electrode 33 is set, for example, in a range of 1 μm to 100 μm.

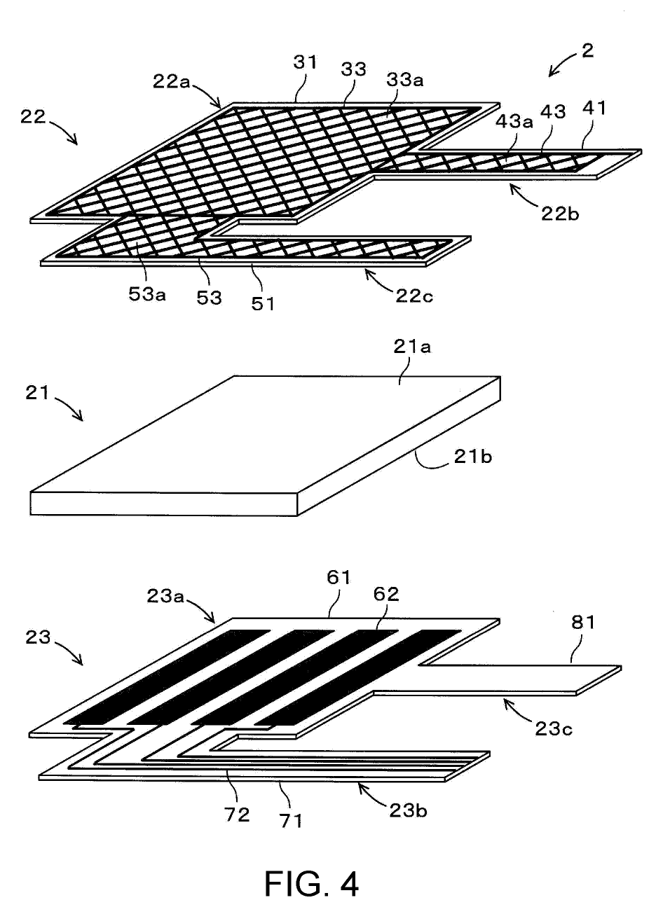

The first shield electrode 33 is disposed overlapping the first detection electrode 32 when viewed from the thickness direction (up-down direction) of the first shield electrode 33 and has an outer shape that includes the outer shape of the first detection electrode 32, as shown in FIGS. 4 and 6 to 8. That is, when viewed from the thickness direction of the first shield electrode 33, the outer shape that is the contour of the first shield electrode 33 is configured to encompass the first detection electrode 32.

Furthermore, the first shield electrode 33 includes a plurality of first openings 33a penetrating in the thickness direction of the first shield electrode 33. In the present embodiment, the first shield electrode 33 has an outer frame formed in a linear shape, and an inner region (frame interior) is also formed in a linear shape. In particular, the first shield electrode 33 has the inner region formed in a lattice shape and has rectangular first openings 33a. However, the first openings 33a may be circular or other polygonal shapes in addition to rectangular. Further, in the present embodiment, the first shield electrode 33 has the linear shape of the inner region formed at an angle with respect to the sides of the outer frame. However, the first shield electrode 33 may have the linear shape of the inner region formed parallel to the sides of the outer frame.

In this way, since the first shield electrode 33 has a plurality of first openings 33a, it is disposed to face only a part of the first detection electrode 32. That is, the material forming the first shield electrode 33 does not exist at positions of the first detection electrode 32 corresponding to the first openings 33a. It is noted that the first shield electrode 33 may have a part located in a region where the first detection electrode 32 does not exist when viewed from the thickness direction of the first shield electrode 33.

Here, as described above, the first shield electrode 33 is configured to electromagnetically shield the first detection electrode 32. Even in a case where the first shield electrode 33 has the first openings 33a, the maximum span dimension of the first openings 33a is set so that target noise may be shielded. The maximum span dimension of the first opening 33a is the length of the diagonal of the rectangle in response to the first opening 33a being rectangular. The maximum span dimension of the first opening 33a is the diameter in response to the first opening 33a being circular.

In the present embodiment, the plurality of first openings 33a are set to the same shape. However, the plurality of first openings 33a may be set to different shapes and sizes depending on the region. For example, the maximum span dimensions of the plurality of first openings 33a may be set in a plurality of settings according to the frequency of the noise that is the target to be electromagnetically shielded by the first shield electrode 33.

The first sensor protective film 34, as shown in FIGS. 2 and 6 to 7, is formed of an insulating material and covers the outer surface of the first shield electrode 33. At the locations of the first openings 33a of the first shield electrode 33, the first insulator sheet 31 faces outward. Thus, the first sensor protective film 34 covers those locations of the first insulator sheet 31. In the present embodiment, the first sensor protective film 34 is formed by printing an insulating material on the outer surface of the first shield electrode 33. Thus, the first sensor protective film 34 is a printed formation adhered to the outer surface of the first shield electrode 33 and a part of the outer surface of the first insulator sheet 31.

The first sensor protective film 34 may be made of any material as long as it is an insulating material. For example, the first sensor protective film 34 may be made of epoxy resin, phenol resin, or the like having curability by heat or ultraviolet light, insulating properties, heat resistance, and the like. The thickness of the first sensor protective film 34 is set, for example, in a range of 1 μm to 100 μm.

The first wiring portion 22b includes a first main extension insulator sheet 41, a first wiring 42, a first main wiring shield electrode 43, and a first wiring protective film 44 (shown in FIGS. 2 and 7).

The first main extension insulator sheet 41 is, for example, a resin sheet. As shown in FIGS. 2 to 8, the first main extension insulator sheet 41 extends from a side edge of the first insulator sheet 31 in the planar direction of the first insulator sheet 31. The first main extension insulator sheet 41 is located at a position where the insulator sheet body 21 does not exist. In the present embodiment, the first main extension insulator sheet 41 is formed of a resin sheet integral with the first insulator sheet 31. Thus, the first main extension insulator sheet 41 is formed of the same type of material as the first insulator sheet 31 and has the same thickness.

The first wiring 42, as shown in FIGS. 5 to 8, is disposed on the inner surface side of the first main extension insulator sheet 41. In the present embodiment, the first wiring 42 is adhered to the inner surface of the first main extension insulator sheet 41. The first wiring 42 is formed by printing a conductive material on the inner surface of the first main extension insulator sheet 41. Thus, the first wiring 42 is a printed formation adhered to the inner surface of the first main extension insulator sheet 41.

The first wiring 42 is electrically connected to the first detection electrode 32. The first wiring 42 is formed of the same type of material as the first detection electrode 32 and has the same thickness. In the present embodiment, the first wiring 42 is formed by printing simultaneously with the first detection electrode 32.

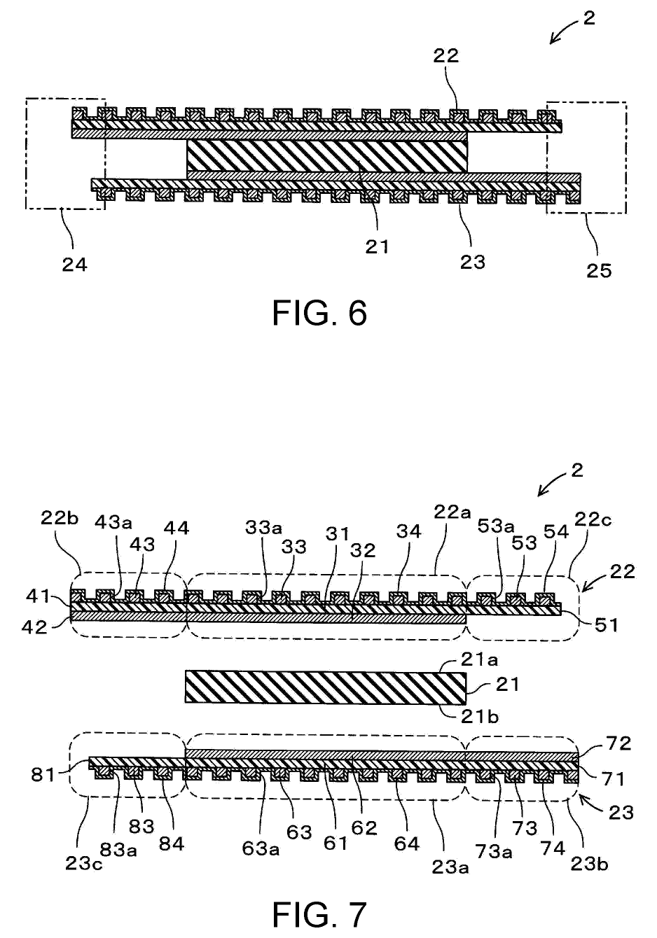

The first wiring 42 is connected to each of the plurality of strip electrodes constituting the first detection electrode 32. The first wiring 42 is formed such that one end is connected to the first detection electrode 32 and the other end reaches a position at a tip of the first main extension insulator sheet 41. The first wiring 42 is electrically connected to the connector 24 shown in FIG. 6.

The first main wiring shield electrode 43 is configured to electromagnetically shield the first wiring 42. The first main wiring shield electrode 43, as shown in FIGS. 4 and 6 to 8, is disposed on the outer surface side of the first main extension insulator sheet 41. In the present embodiment, the first main wiring shield electrode 43 is adhered to the outer surface of the first main extension insulator sheet 41. The first main wiring shield electrode 43 is formed by printing a conductive material on the outer surface of the first main extension insulator sheet 41. Thus, the first main wiring shield electrode 43 is a printed formation adhered to the outer surface of the first main extension insulator sheet 41.

The first main wiring shield electrode 43 is electrically connected to the first shield electrode 33. The first main wiring shield electrode 43 is formed of the same type of material as the first shield electrode 33 and has the same thickness. In the present embodiment, the first main wiring shield electrode 43 is formed by printing simultaneously with the first shield electrode 33.

The first main wiring shield electrode 43, as shown in FIGS. 4 and 6 to 8, is disposed overlapping the first wiring 42 when viewed from the thickness direction of the first main wiring shield electrode 43 and has an outer shape including an outer shape of the first wiring 42 excluding a region of the connector 24. That is, when viewed from the thickness direction of the first main wiring shield electrode 43, the outer shape that is the contour of the first main wiring shield electrode 43 is configured to encompass the part of the first wiring 42 excluding the region of the connector 24.

The first main wiring shield electrode 43 is formed such that one end is connected to the first shield electrode 33 and the other end reaches a position at a tip of the first main extension insulator sheet 41. The first main wiring shield electrode 43 is electrically connected to the connector 24 shown in FIG. 6.

Furthermore, the first main wiring shield electrode 43 includes a plurality of third openings 43a penetrating in the thickness direction of the first main wiring shield electrode 43. In the present embodiment, the first main wiring shield electrode 43 has an outer frame formed in a linear shape, and an inner region (frame interior) is also formed in a linear shape. In particular, the first main wiring shield electrode 43 has the inner region formed in a lattice shape and has rectangular third openings 43a. However, the third openings 43a may be circular or other polygonal shapes in addition to rectangular. Further, in the present embodiment, the first main wiring shield electrode 43 has the linear shape of the inner region formed at an angle with respect to the sides of the outer frame. However, the first main wiring shield electrode 43 may have the linear shape of the inner region formed parallel to the sides of the outer frame.

In this way, since the first main wiring shield electrode 43 has a plurality of third openings 43a, the first main wiring shield electrode 43 is disposed so as to face only a part of the first wiring 42. That is, the material forming the first main wiring shield electrode 43 does not exist at positions of the first wiring 42 corresponding to the third openings 43a. It is noted that the first main wiring shield electrode 43 may have a part located in a region where the first wiring 42 does not exist when viewed from the thickness direction of the first main wiring shield electrode 43.

Here, as described above, the first main wiring shield electrode 43 is configured to electromagnetically shield the first wiring 42. Even in a case where the first main wiring shield electrode 43 has the third openings 43a, the maximum span dimension of the third openings 43a is set so that target noise may be shielded.

In the present embodiment, the plurality of third openings 43a are set to the same shape. Furthermore, the plurality of third openings 43a are formed in the same shape as the first openings 33a. Thus, the span dimension of the third openings 43a is also the same as the maximum span dimension of the first openings 33a. However, the third openings 43a may be set to a different shape and size from the first openings 33a. Further, the plurality of third openings 43a may be set to different shapes and sizes depending on the region. For example, the maximum span dimensions of the plurality of third openings 43a may be set in a plurality of settings according to the frequency of the noise that is the target to be electromagnetically shielded by the first main wiring shield electrode 43.

As shown in FIGS. 2 and 6 to 7, the first wiring protective film 44 is formed of an insulating material and covers the outer surface of the first main wiring shield electrode 43. At the locations of the third openings 43a of the first main wiring shield electrode 43, the first main extension insulator sheet 41 faces outward. Thus, the first wiring protective film 44 covers the corresponding locations of the first main extension insulator sheet 41. In the present embodiment, the first wiring protective film 44 is formed by printing an insulating material on the outer surface of the first main wiring shield electrode 43. Thus, the first wiring protective film 44 is a printed formation adhered to the outer surface of the first main wiring shield electrode 43 and a part of the first main extension insulator sheet 41.

The first wiring protective film 44 is connected to the first sensor protective film 34. The first wiring protective film 44 is formed of the same type of material as the first sensor protective film 34 and has the same thickness. In the present embodiment, the first wiring protective film 44 is formed by printing simultaneously with the first sensor protective film 34.

The first dummy wiring portion 22c includes a first sub-extension insulator sheet 51, a first sub-wiring shield electrode 53, and a first dummy wiring protective film 54 (shown in FIGS. 2 and 7).

The first sub-extension insulator sheet 51 is, for example, a resin sheet. As shown in FIGS. 2 to 8, the first sub-extension insulator sheet 51 extends from a side edge of the first insulator sheet 31 in the planar direction of the first insulator sheet 31. The first sub-extension insulator sheet 51 is located at a position where the insulator sheet body 21 does not exist. In the present embodiment, the first sub-extension insulator sheet 51 is formed of a resin sheet integral with the first insulator sheet 31. Thus, the first sub-extension insulator sheet 51 is formed of the same type of material as the first insulator sheet 31 and has the same thickness.

Here, as shown in FIG. 5, the first wiring 42 is formed on the inner surface of the first main extension insulator sheet 41 as described above. On the other hand, no conductive material such as electrodes or wiring is formed on the inner surface of the first sub-extension insulator sheet 51. Thus, on the inner surface of the first sub-extension insulator sheet 51, the first sub-extension insulator sheet 51 is exposed over the entire region.

The first sub-extension insulator sheet 51 is disposed in a non-adhesive manner to a second main extension insulator sheet 71 of the second wiring portion 23b of the second electrode unit 23 described later and is disposed facing the second main extension insulator sheet 71. The first sub-extension insulator sheet 51 is formed in the same shape as the second main extension insulator sheet 71. Thus, the first sub-extension insulator sheet 51 is disposed so as to face the entire region of the second main extension insulator sheet 71.

The first sub-wiring shield electrode 53 is configured to electromagnetically shield a second wiring 72 of the second wiring portion 23b of the second electrode unit 23 described later. The first sub-wiring shield electrode 53 is disposed on the outer surface side of the first sub-extension insulator sheet 51, as shown in FIGS. 4 and 6 to 8. In the present embodiment, the first sub-wiring shield electrode 53 is formed by printing on the outer surface of the first sub-extension insulator sheet 51. Thus, the first sub-wiring shield electrode 53 is a printed formation adhered to the outer surface of the first sub-extension insulator sheet 51.

The first sub-wiring shield electrode 53 is electrically connected to the first shield electrode 33. The first sub-wiring shield electrode 53 is formed of the same type of material as the first shield electrode 33 and has the same thickness. In the present embodiment, the first sub-wiring shield electrode 53 is formed by printing simultaneously with the first shield electrode 33.

As shown in FIGS. 4 and 6 to 9, the first sub-wiring shield electrode 53 is disposed overlapping the second wiring 72 when viewed from the thickness direction of the first sub-wiring shield electrode 53 and has an outer shape including the outer shape of the second wiring 72 excluding the region of the connector 25. That is, when viewed from the thickness direction of the first sub-wiring shield electrode 53, the outer shape that is the contour of the first sub-wiring shield electrode 53 is configured to encompass the part of the second wiring 72 excluding the region of the connector 25.

Furthermore, the first sub-wiring shield electrode 53 includes a plurality of fifth openings 53a penetrating in the thickness direction of the first sub-wiring shield electrode 53. In the present embodiment, the first sub-wiring shield electrode 53 has an outer frame formed in a linear shape, and an inner region (frame interior) is also formed in a linear shape. In particular, the first sub-wiring shield electrode 53 has the inner region formed in a lattice shape and has rectangular fifth openings 53a. However, the fifth openings 53a may be circular or other polygonal shapes in addition to rectangular. Further, in the present embodiment, the first sub-wiring shield electrode 53 has the linear shape of the inner region formed at an angle with respect to the sides of the outer frame. However, the first sub-wiring shield electrode 53 may have the linear shape of the inner region formed parallel to the sides of the outer frame.

In this way, since the first sub-wiring shield electrode 53 has a plurality of fifth openings 53a, the first sub-wiring shield electrode 53 is disposed so as to face only a part of the second wiring 72. That is, the material forming the first sub-wiring shield electrode 53 does not exist at positions of the second wiring 72 corresponding to the fifth openings 53a. The first sub-wiring shield electrode 53 may have a part located in a region where the second wiring 72 does not exist when viewed from the thickness direction of the first sub-wiring shield electrode 53.

Here, as described above, the first sub-wiring shield electrode 53 is configured to electromagnetically shield the second wiring 72. Even in the case where the first sub-wiring shield electrode 53 has the fifth openings 53a, the maximum span dimension of the fifth openings 53a is set so that target noise may be shielded.

In the present embodiment, the plurality of fifth openings 53a are set to the same shape. Furthermore, the plurality of fifth openings 53a are formed in the same shape as the first openings 33a. Thus, the span dimension of the fifth openings 53a is also the same as the maximum span dimension of the first openings 33a. However, the fifth openings 53a may be set to a different shape and size from the first openings 33a. Further, the plurality of fifth openings 53a may be set to different shapes and sizes depending on the region. For example, the maximum span dimensions of the plurality of fifth openings 53a may be set in a plurality of settings according to the frequency of the noise that is the target to be electromagnetically shielded by the first sub-wiring shield electrode 53.

The first dummy wiring protective film 54, as shown in FIGS. 2 and 6 to 7, is formed of an insulating material and covers the outer surface of the first sub-wiring shield electrode 53. At the locations of the fifth openings 53a of the first sub-wiring shield electrode 53, the first sub-extension insulator sheet 51 faces outward. Thus, the first dummy wiring protective film 54 covers the corresponding locations of the first sub-extension insulator sheet 51. In the present embodiment, the first dummy wiring protective film 54 is formed by printing an insulating material on the outer surface of the first sub-wiring shield electrode 53. Thus, the first dummy wiring protective film 54 is a printed formation adhered to the outer surface of the first sub-wiring shield electrode 53 and a part of the first sub-extension insulator sheet 51.

The first dummy wiring protective film 54 is connected to the first sensor protective film 34. The first dummy wiring protective film 54 is formed of the same type of material as the first sensor protective film 34 and has the same thickness. In the present embodiment, the first dummy wiring protective film 54 is formed by printing simultaneously with the first sensor protective film 34.

### 5-2. Details of second electrode unit 23

Details of the second electrode unit 23, which is a component of the pressure sensor 2, will be described with reference to FIGS. 2 to 7 and 9. As described above, the second electrode unit 23 includes a second sensor electrode portion 23a, a second wiring portion 23b, and a second dummy wiring portion 23c.

The second sensor electrode portion 23a is disposed facing the first sensor electrode portion 22a with the insulator sheet body 21 interposed therebetween. The second sensor electrode portion 23a includes a second insulator sheet 61, a second detection electrode 62, a second shield electrode 63, and a second sensor protective film 64 (shown in FIGS. 3 and 7).

The second insulator sheet 61 is disposed so as to face the second surface 21b of the insulator sheet body 21. The second insulator sheet 61 is formed similarly to the first insulator sheet 31. For example, the thickness of the second insulator sheet 61 is equal to or less than the thickness of the insulator sheet body 21. The same applies to other configurations.

The second detection electrode 62 is disposed on the inner surface side of the second insulator sheet 61. Thus, the second detection electrode 62 is disposed on the second surface 21b side of the insulator sheet body 21, and the second insulator sheet 61 is disposed on the outer surface side of the second detection electrode 62. In the present embodiment, the second detection electrode 62 is disposed in a non-adhesive manner to the insulator sheet body 21. The second detection electrode 62 is disposed so as to overlap the first detection electrode 32. That is, when viewed from the thickness direction of the insulator sheet body 21, at least a portion of the second detection electrode 62 is disposed so as to overlap the first detection electrode 32.

The second detection electrode 62 is formed into plurality of strip electrodes parallel to one side of the rectangle of the second insulator sheet 61, as shown in FIG. 4 and FIG. 9. In the present embodiment, the second detection electrode 62 has four strip electrodes, but may have any number of strip electrodes. Further, the direction in which each strip electrode of the second detection electrode 62 extends is a direction intersecting the direction in which each strip electrode of the first detection electrode 32 extends. In the present embodiment, the directions in which both strip electrodes extend have an angle of 90 degrees. Thus, when viewed from the thickness direction of the insulator sheet body 21, there are 16 locations where the first detection electrode 32 and the second detection electrode 62 overlap. However, this number may be set arbitrarily.

It is noted that the second detection electrode 62 may be, for example, a plurality of electrodes arranged in a matrix of a plurality of rows × a plurality of columns. For example, in response to the second detection electrode 62 being arranged in 4 rows × 4 columns, there are 16 electrodes. Further, in response to the first detection electrode 32 being electrodes arranged in a plurality of rows × a plurality of columns, the second detection electrode 62 may be a single electrode.

The second detection electrode 62 is formed similarly to the first detection electrode 32. Further, the relationship between the second detection electrode 62 and the second insulator sheet 61 is configured similarly to the relationship between the first detection electrode 32 and the first insulator sheet 31. For example, the second detection electrode 62 is a printed formation adhered to the inner surface of the second insulator sheet 61. The same applies to other configurations.

The second shield electrode 63 is configured to electromagnetically shield the second detection electrode 62. The second shield electrode 63 is disposed on the outer surface side of the second insulator sheet 61. The second shield electrode 63 is formed similarly to the first shield electrode 33. Further, the relationship between the second shield electrode 63 and the second insulator sheet 61 is configured similarly to the relationship between the first shield electrode 33 and the first insulator sheet 31. For example, the second shield electrode 63 is a printed formation adhered to the outer surface of the second insulator sheet 61. The same applies to other configurations.

Then, the second shield electrode 63, when viewed from the thickness direction of the second shield electrode 63, is disposed overlapping the second detection electrode 62 and has an outer shape that includes the outer shape of the second detection electrode 62. Furthermore, the second shield electrode 63 includes a plurality of second openings 63a penetrating in the thickness direction of the second shield electrode 63. The second openings 63a are formed similarly to the first openings 33a. However, the second openings 63a may be formed differently from the first openings 33a.

In the present embodiment, the plurality of second openings 63a are set to the same shape. However, the plurality of second openings 63a may be set to different shapes and sizes depending on the region. For example, the maximum span dimensions of the plurality of second openings 63a may be set in a plurality of settings according to the frequency of noise that is the target to be electromagnetically shielded by the second shield electrode 63. The maximum span dimension of the second openings 63a may be the same as or different from the maximum span dimension of the first openings 33a.

The second sensor protective film 64 is formed of an insulating material and covers the outer surface of the second shield electrode 63. The second sensor protective film 64 is formed similarly to the first sensor protective film 34. Further, the relationship between the second sensor protective film 64, the second shield electrode 63, and the second insulator sheet 61 is configured similarly to the relationship between the first sensor protective film 34, the first shield electrode 33, and the first insulator sheet 31. For example, the second sensor protective film 64 is a printed formation adhered to the outer surface of the second shield electrode 63 and a part of the outer surface of the second insulator sheet 61. The same applies to other configurations.

The second wiring portion 23b is disposed facing the first dummy wiring portion 22c without the insulator sheet body 21 interposed therebetween. However, an insulator sheet similar to the insulator sheet body 21 may be disposed between the second wiring portion 23b and the first dummy wiring portion 22c. The second wiring portion 23b includes a second main extension insulator sheet 71, a second wiring 72, a second main wiring shield electrode 73, and a second wiring protective film 74 (shown in FIGS. 3 and 7).

The second main extension insulator sheet 71 extends from the side edge of the second insulator sheet 61 in the planar direction of the second insulator sheet 61. The second main extension insulator sheet 71 is formed of a resin sheet integral with the second insulator sheet 61. The second main extension insulator sheet 71 is disposed facing the first sub-extension insulator sheet 51 and is disposed non-adhered to the first sub-extension insulator sheet 51. The second main extension insulator sheet 71 is formed similarly to the first sub-extension insulator sheet 51.

However, the second main extension insulator sheet 71 is formed slightly longer than the first sub-extension insulator sheet 51. Thus, there is a region at the tip part of the second main extension insulator sheet 71 that does not face the first sub-extension insulator sheet 51.

The second wiring 72 is disposed on the inner surface side of the second main extension insulator sheet 71 and is electrically connected to the second detection electrode 62. The second wiring 72 is formed similarly to the first wiring 42. For example, the second wiring 72 is a printed formation adhered to the inner surface of the second main extension insulator sheet 71. The same applies to other configurations. Then, the second wiring 72 is electrically connected to the connector 25 shown in FIG. 6. The tip part of the second wiring 72 becomes a region that does not face the first sub-extension insulator sheet 51. This region is electrically connected to the terminal of the connector 25.

The second main wiring shield electrode 73 is configured to electromagnetically shield the second wiring 72. The second main wiring shield electrode 73 is disposed on the outer surface side of the second main extension insulator sheet 71. The second main wiring shield electrode 73 is electrically connected to the second shield electrode 63. The second main wiring shield electrode 73 is formed similarly to the first main wiring shield electrode 43. Further, the relationship between the second main wiring shield electrode 73 and the second main extension insulator sheet 71 is configured similarly to the relationship between the first main wiring shield electrode 43 and the first main extension insulator sheet 41. For example, the second main wiring shield electrode 73 is a printed formation adhered to the outer surface of the second main extension insulator sheet 71. The same applies to other configurations.

The second main wiring shield electrode 73 has one end connected to the second shield electrode 63 and is formed to a position where the other end reaches the tip of the second main extension insulator sheet 71. The second main wiring shield electrode 73 is electrically connected to the connector 25 shown in FIG. 6.

The second main wiring shield electrode 73 is disposed to overlap the second wiring 72 when viewed from the thickness direction of the second main wiring shield electrode 73 and has an outer shape that includes the outer shape of the second wiring 72 excluding the region of the connector 25. In other words, when viewed from the thickness direction of the second main wiring shield electrode 73, the outer shape that is the contour of the second main wiring shield electrode 73 is configured to encompass the part of the second wiring 72 excluding the region of the connector 25.

Furthermore, the second main wiring shield electrode 73 includes a plurality of fourth openings 73a penetrating in the thickness direction of the second main wiring shield electrode 73. The fourth openings 73a are formed similarly to the third openings 43a. The fourth openings 73a may be formed differently from the third openings 43a.

In the present embodiment, the plurality of fourth openings 73a are set to the same shape. However, the plurality of fourth openings 73a may be set to different shapes and sizes depending on the region. For example, the maximum span dimensions of the plurality of fourth openings 73a may be set in a plurality of settings according to the frequency of noise that is the target to be electromagnetically shielded by the second main wiring shield electrode 73. The maximum span dimension of the fourth openings 73a may be the same as or different from the maximum span dimension of the third openings 43a.

The second wiring protective film 74 is formed of an insulating material and covers the outer surface of the second main wiring shield electrode 73. The second wiring protective film 74 is formed similarly to the first wiring protective film 44. The relationship between the second wiring protective film 74, the second main wiring shield electrode 73, and the second main extension insulator sheet 71 is configured similarly to the relationship between the first wiring protective film 44, the first main wiring shield electrode 43, and the first main extension insulator sheet 41. For example, the second wiring protective film 74 is a printed formation adhered to the outer surface of the second main wiring shield electrode 73 and a part of the outer surface of the second main extension insulator sheet 71. The same applies to other configurations.

The second dummy wiring portion 23c is disposed facing the first wiring portion 22b without the insulator sheet body 21 interposed therebetween. However, an insulator sheet similar to the insulator sheet body 21 may be disposed between the second dummy wiring portion 23c and the first wiring portion 22b. The second dummy wiring portion 23c includes a second sub-extension insulator sheet 81, a second sub-wiring shield electrode 83, and a second dummy wiring protective film 84 (shown in FIGS. 3 and 7).

The second sub-extension insulator sheet 81 extends from the side edge of the second insulator sheet 61 in the planar direction of the second insulator sheet 61. The second sub-extension insulator sheet 81 is formed of a resin sheet integral with the second insulator sheet 61. The second sub-extension insulator sheet 81 is disposed facing the first main extension insulator sheet 41 and is disposed non-adhered to the first main extension insulator sheet 41. The second sub-extension insulator sheet 81 is formed similarly to the first main extension insulator sheet 41.

However, the second sub-extension insulator sheet 81 is formed slightly shorter than the first main extension insulator sheet 41. Thus, there is a region at the tip part of the first main extension insulator sheet 41 that does not face the second sub-extension insulator sheet 81. Accordingly, the tip part of the first wiring 42 becomes a region that does not face the second sub-extension insulator sheet 81. This region is electrically connected to the terminal of the connector 24.

The second sub-wiring shield electrode 83 is configured to electromagnetically shield the first wiring 42 of the first wiring portion 22b of the first electrode unit 22. The second sub-wiring shield electrode 83 is disposed on the outer surface side of the second sub-extension insulator sheet 81. The second sub-wiring shield electrode 83 is electrically connected to the second shield electrode 63. The second sub-wiring shield electrode 83 is formed similarly to the first sub-wiring shield electrode 53. Further, the relationship between the second sub-wiring shield electrode 83 and the second sub-extension insulator sheet 81 is configured similarly to the relationship between the first sub-wiring shield electrode 53 and the first sub-extension insulator sheet 51. For example, the second sub-wiring shield electrode 83 is a printed formation adhered to the outer surface of the second sub-extension insulator sheet 81. The same applies to other configurations.

Then, the second sub-wiring shield electrode 83 is disposed overlapping the first wiring 42 when viewed from the thickness direction of the second sub-wiring shield electrode 83 and has an outer shape that includes the outer shape of the first wiring 42 excluding the region of the connector 24. That is, when viewed from the thickness direction of the second sub-wiring shield electrode 83, the outer shape that is the contour of the second sub-wiring shield electrode 83 is configured to encompass the part of the first wiring 42 excluding the region of the connector 24.

The second sub-wiring shield electrode 83 includes a plurality of sixth openings 83a penetrating in the thickness direction of the second sub-wiring shield electrode 83. The sixth openings 83a are formed similarly to the fifth openings 53a. The sixth openings 83a may be formed differently from the fifth openings 53a.

In the present embodiment, the plurality of sixth openings 83a are set to the same shape. However, the plurality of sixth openings 83a may be set to different shapes and sizes depending on the region. For example, the maximum span dimensions of the plurality of sixth openings 83a may be set in a plurality of settings according to the frequency of the noise that is the target to be electromagnetically shielded by the second sub-wiring shield electrode 83. The maximum span dimension of the sixth openings 83a may be the same as or different from the maximum span dimension of the fifth openings 53a.

The second dummy wiring protective film 84 is formed of an insulating material and covers the outer surface of the second sub-wiring shield electrode 83. The second dummy wiring protective film 84 is formed similarly to the first dummy wiring protective film 54. Further, the relationship between the second dummy wiring protective film 84, the second sub-wiring shield electrode 83, and the second sub-extension insulator sheet 81 is configured similarly to the relationship between the first dummy wiring protective film 54, the first sub-wiring shield electrode 53, and the first sub-extension insulator sheet 51. For example, the second dummy wiring protective film 84 is a printed formation adhered to the outer surface of the second sub-wiring shield electrode 83 and a part of the outer surface of the second sub-extension insulator sheet 81. The same applies to other configurations.

### 6. Functions and Effects

The functions and effects of the present embodiment will be described.

The pressure sensor 2 includes an insulator sheet body 21, a first detection electrode 32 disposed on a first surface 21a side of the insulator sheet body 21, a second detection electrode 62 disposed on a second surface 21b side of the insulator sheet body 21 and disposed to overlap the first detection electrode 32, a first insulator sheet 31 disposed on an outer surface side of the first detection electrode 32, and a first shield electrode 33 disposed on an outer surface side of the first insulator sheet 31 and electromagnetically shielding the first detection electrode 32. By including the first shield electrode 33, the pressure sensor 2 may reduce the influence of noise that the first detection electrode 32 receives from the outside. As a result, the detection accuracy of the pressure sensor 2 may be improved.

The thickness of the first insulator sheet 31 is equal to or less than the thickness of the insulator sheet body 21. Thus, the thickness of the entire pressure sensor 2 may be reduced. This may improve the seating comfort of a seated person seated on the seat 10 on which the pressure sensor 2 is disposed. Further, the sleeping comfort of a user utilizing bedding on which the pressure sensor 2 is disposed may be improved. In this way, it is possible to suppress causing discomfort to users of the seat 10, bedding, or the like on which the pressure sensor 2 is disposed.

More preferably, the thickness of the first insulator sheet 31 may be thinner than the thickness of the insulator sheet body 21. In this case, it is possible to more effectively suppress causing discomfort to the user.

Furthermore, the first shield electrode 33 is disposed to overlap the first detection electrode 32 when viewed from the thickness direction of the first shield electrode 33, has an outer shape that includes the outer shape of the first detection electrode 32, and includes a plurality of first openings 33a penetrating in the thickness direction of the first shield electrode 33. By providing the first shield electrode 33 with the plurality of first openings 33a, the area where the first detection electrode 32 and the first shield electrode 33 face each other may be reduced. As a result, the parasitic capacity generated between the first detection electrode 32 and the first shield electrode 33 may be reduced. This may improve the detection sensitivity of the pressure sensor 2.

Further, the pressure sensor 2 further includes a second insulator sheet 61 disposed on an outer surface side of the second detection electrode 62 and a second shield electrode 63 disposed on an outer surface side of the second insulator sheet 61 and electromagnetically shielding the second detection electrode 62. By including the second shield electrode 63, the pressure sensor 2 may reduce the influence of noise that the second detection electrode 62 receives from the outside. As a result, the detection accuracy of the pressure sensor 2 may be improved.

The thickness of the second insulator sheet 61 is equal to or less than the thickness of the insulator sheet body 21. This may suppress causing discomfort to users of the seat 10, bedding, or the like on which the pressure sensor 2 is disposed. More preferably, the thickness of the first insulator sheet 31 may be thinner than the thickness of the insulator sheet body 21. In this case, it is possible to more effectively suppress causing discomfort to the user.

Furthermore, the second shield electrode 63 is disposed to overlap the second detection electrode 62 when viewed from the thickness direction of the second shield electrode 63, has an outer shape that includes the outer shape of the second detection electrode 62, and includes a plurality of second openings 63a penetrating in the thickness direction of the second shield electrode 63. By providing the second shield electrode 63 with the plurality of second openings 63a, the area where the second detection electrode 62 and the second shield electrode 63 face each other may be reduced. As a result, the parasitic capacity generated between the second detection electrode 62 and the second shield electrode 63 may be reduced. This may improve the detection sensitivity of the pressure sensor 2.

Further, the pressure sensor 2 is configured to include a first electrode unit 22 disposed on the first surface 21a side of the insulator sheet body 21 and configured as a separate body from the insulator sheet body 21. The first electrode unit 22 includes a first insulator sheet 31, a first detection electrode 32 adhered to the inner surface of the first insulator sheet 31 and disposed non-adhered to the insulator sheet body 21, and a first shield electrode 33 adhered to the outer surface of the first insulator sheet 31.

In this manner, the first insulator sheet 31, the first detection electrode 32, and the first shield electrode 33 constitute the first electrode unit 22. By having such a simple configuration, manufacturing becomes easy, and cost reduction may be achieved. Furthermore, the distance between the first detection electrode 32 and the first shield electrode 33 may be maintained in a stable state. As a result, fluctuation of the parasitic capacity between the first detection electrode 32 and the first shield electrode 33 may be suppressed. Thus, the detection sensitivity of the pressure sensor 2 may be improved.

Furthermore, the first detection electrode 32 is a printed formation adhered to the inner surface of the first insulator sheet 31, and the first shield electrode 33 is a printed formation adhered to the outer surface of the first insulator sheet 31. In this case, the first detection electrode 32 and the first shield electrode 33 may be positioned with high accuracy. As a result, desired shielding performance may be obtained, and the detection accuracy of the pressure sensor 2 may be improved.

Further, the pressure sensor 2 is configured to include, in addition to the first electrode unit 22, a second electrode unit 23 disposed on the second surface 21b side of the insulator sheet body 21, disposed to overlap the first electrode unit 22, and configured as a separate body from the insulator sheet body 21.

The second electrode unit 23 includes a second insulator sheet 61, a second detection electrode 62 adhered to the inner surface of the second insulator sheet 61 and disposed non-adhered to the insulator sheet body 21, and a second shield electrode 63 adhered to the outer surface of the second insulator sheet 61.

In this manner, the second insulator sheet 61, the second detection electrode 62, and the second shield electrode 63 constitute the second electrode unit 23. By having such a simple configuration, manufacturing becomes easy, and cost reduction may be achieved. Furthermore, the distance between the second detection electrode 62 and the second shield electrode 63 may be maintained in a stable state. As a result, fluctuation of the parasitic capacity between the second detection electrode 62 and the second shield electrode 63 may be suppressed. Thus, the detection sensitivity of the pressure sensor 2 may be improved.

Furthermore, the second detection electrode 62 is a printed formation adhered to the inner surface of the second insulator sheet 61, and the second shield electrode 63 is a printed formation adhered to the outer surface of the second insulator sheet 61. In this case, the second detection electrode 62 and the second shield electrode 63 may be positioned with high accuracy. As a result, desired shielding performance may be obtained, and the detection accuracy of the pressure sensor 2 may be improved.

Further, the pressure sensor 2 further includes a first main extension insulator sheet 41 extended in the planar direction of the first insulator sheet 31 from a side edge of the first insulator sheet 31, a first wiring 42 disposed on the inner surface side of the first main extension insulator sheet 41 and electrically connected to the first detection electrode 32, and a first main wiring shield electrode 43 disposed on the outer surface side of the first main extension insulator sheet 41, electrically connected to the first shield electrode 33, and electromagnetically shielding the first wiring 42. By including the first main wiring shield electrode 43, the pressure sensor 2 may reduce the influence of noise that the first wiring 42 receives from outside. As a result, the detection accuracy of the pressure sensor 2 may be improved.

Furthermore, the first main wiring shield electrode 43 is disposed overlapping the first wiring 42 when viewed from the thickness direction of the first main wiring shield electrode 43, has an outer shape including the outer shape of the first wiring 42 excluding the region of the connector 24, and includes a plurality of third openings 43a penetrating in the thickness direction of the first main wiring shield electrode 43. By providing the first main wiring shield electrode 43 with the plurality of third openings 43a, the area where the first wiring 42 and the first main wiring shield electrode 43 face each other may be reduced. As a result, the parasitic capacity generated between the first wiring 42 and the first main wiring shield electrode 43 may be reduced. This may improve the detection sensitivity of the pressure sensor 2.

Furthermore, the first electrode unit 22 is configured to include the first main extension insulator sheet 41, the first wiring 42, and the first main wiring shield electrode 43. Thereby, the pressure sensor 2 has a simple configuration. Furthermore, the first wiring 42 and the first main wiring shield electrode 43 may be connected to a common connector 24. Thereby, miniaturization of the pressure sensor 2 may be achieved.

Further, the pressure sensor 2 further includes a second main extension insulator sheet 71 extended in the planar direction of the second insulator sheet 61 from a side edge of the second insulator sheet 61, a second wiring 72 disposed on the inner surface side of the second main extension insulator sheet 71 and electrically connected to the second detection electrode 62, and a second main wiring shield electrode 73 disposed on the outer surface side of the second main extension insulator sheet 71, electrically connected to the second shield electrode 63, and electromagnetically shielding the second wiring 72. By including the second main wiring shield electrode 73, the pressure sensor 2 may reduce the influence of noise that the second wiring 72 receives from outside. As a result, the detection accuracy of the pressure sensor 2 may be improved.

Furthermore, the second main wiring shield electrode 73 is disposed overlapping the second wiring 72 when viewed from the thickness direction of the second main wiring shield electrode 73, has an outer shape including the outer shape of the second wiring 72 excluding the region of the connector 25, and includes a plurality of fourth openings 73a penetrating in the thickness direction of the second main wiring shield electrode 73. By providing the second main wiring shield electrode 73 with the plurality of fourth openings 73a, the area where the second wiring 72 and the second main wiring shield electrode 73 face each other may be reduced. As a result, the parasitic capacity generated between the second wiring 72 and the second main wiring shield electrode 73 may be reduced. This may improve the detection sensitivity of the pressure sensor 2.

Furthermore, the second electrode unit 23 is configured to include the second main extension insulator sheet 71, the second wiring 72, and the second main wiring shield electrode 73. Thereby, the pressure sensor 2 has a simple configuration. Furthermore, the second wiring 72 and the second main wiring shield electrode 73 may be connected to a common connector 25. Thereby, miniaturization of the pressure sensor 2 may be achieved.

Further, the pressure sensor 2 further includes a first sub-extension insulator sheet 51 extended in the planar direction of the first insulator sheet 31 from a side edge of the first insulator sheet 31, disposed non-adhered to the second main extension insulator sheet 71, and disposed facing the second main extension insulator sheet 71, and a first sub-wiring shield electrode 53 disposed on the outer surface side of the first sub-extension insulator sheet 51, electrically connected to the first shield electrode 33, and electromagnetically shielding the second wiring 72. By including the first sub-wiring shield electrode 53, the pressure sensor 2 may reduce the influence of noise that the second wiring 72 receives from outside. As a result, the detection accuracy of the pressure sensor 2 may be improved.

Furthermore, the first sub-wiring shield electrode 53 is disposed overlapping the second wiring 72 when viewed from the thickness direction of the first sub-wiring shield electrode 53, has an outer shape including the outer shape of the second wiring 72 excluding the region of the connector 25, and includes a plurality of fifth openings 53a penetrating in the thickness direction of the first sub-wiring shield electrode 53. By providing the first sub-wiring shield electrode 53 with the plurality of fifth openings 53a, the area where the second wiring 72 and the first sub-wiring shield electrode 53 face each other may be reduced. As a result, the parasitic capacity generated between the second wiring 72 and the first sub-wiring shield electrode 53 may be reduced. This may improve the detection sensitivity of the pressure sensor 2.

Furthermore, the first electrode unit 22 is configured to include the first sub-extension insulator sheet 51 and the first sub-wiring shield electrode 53. Thereby, the pressure sensor 2 has a simple configuration.

The pressure sensor 2 further includes a second sub-extension insulator sheet 81 extended in the planar direction of the second insulator sheet 61 from a side edge of the second insulator sheet 61, disposed non-adhered to the first main extension insulator sheet 41, and disposed facing the first main extension insulator sheet 41, and a second sub-wiring shield electrode 83 disposed on the outer surface side of the second sub-extension insulator sheet 81, electrically connected to the second shield electrode 63, and electromagnetically shielding the first wiring 42. By including the second sub-wiring shield electrode 83, the pressure sensor 2 may reduce the influence of noise that the first wiring 42 receives from outside. As a result, the detection accuracy of the pressure sensor 2 may be improved.

Furthermore, the second sub-wiring shield electrode 83 is disposed overlapping the first wiring 42 when viewed from the thickness direction of the second sub-wiring shield electrode 83, has an outer shape including the outer shape of the first wiring 42 excluding the region of the connector 24, and includes a plurality of sixth openings 83a penetrating in the thickness direction of the second sub-wiring shield electrode 83. By providing the second sub-wiring shield electrode 83 with the plurality of sixth openings 83a, the area where the first wiring 42 and the second sub-wiring shield electrode 83 face each other may be reduced. As a result, the parasitic capacity generated between the first wiring 42 and the second sub-wiring shield electrode 83 may be reduced. This may improve the detection sensitivity of the pressure sensor 2.

Further, the insulator sheet body 21, the first detection electrode 32, and the second detection electrode 62 are disposed non-adhesively. Thereby, the configuration becomes simple. However, the insulator sheet body 21, the first detection electrode 32, and the second detection electrode 62 may be adhered.

In the first shield electrode 33, the maximum span dimension of the plurality of first openings 33a may be set to the same type. However, the maximum span dimension of the plurality of first openings 33a may be set in a plurality of settings according to the frequency of noise that is the target to be electromagnetically shielded by the first shield electrode 33. The shielding performance may be adjusted according to the frequency of noise that is the suppression target for the first detection electrode 32.

Further, in the second shield electrode 63, the maximum span dimension of the plurality of second openings 63a may be set to the same type. However, the maximum span dimension of the plurality of second openings 63a may be set in a plurality of settings according to the frequency of noise that is the target to be electromagnetically shielded by the second shield electrode 63. The shielding performance may be adjusted according to the frequency of noise that is the suppression target for the second detection electrode 62.

Further, in the first main wiring shield electrode 43, the maximum span dimension of the plurality of third openings 43a may be set to the same type. However, the maximum span dimension of the plurality of third openings 43a may be set in a plurality of settings according to the frequency of noise that is the target to be electromagnetically shielded by the first main wiring shield electrode 43. The shielding performance may be adjusted according to the frequency of noise that is the suppression target for the first wiring 42.

Further, in the second main wiring shield electrode 73, the maximum span dimension of the plurality of fourth openings 73a may be set to the same type. However, the maximum span dimension of the plurality of fourth openings 73a may be set in a plurality of settings according to the frequency of noise that is the target to be electromagnetically shielded by the second main wiring shield electrode 73. The shielding performance may be adjusted according to the frequency of noise that is the suppression target for the second wiring 72.

Further, in the first sub-wiring shield electrode 53, the maximum span dimension of the plurality of fifth openings 53a may be set to the same type. However, the maximum span dimension of the plurality of fifth openings 53a may be set in a plurality of settings according to the frequency of noise that is the target to be electromagnetically shielded by the first sub-wiring shield electrode 53. The shielding performance may be adjusted according to the frequency of noise that is the suppression target for the second wiring 72.

Further, in the second sub-wiring shield electrode 83, the maximum span dimension of the plurality of sixth openings 83a may be set to the same type. However, the maximum span dimension of the plurality of sixth openings 83a may be set in a plurality of settings according to the frequency of noise that is the target to be electromagnetically shielded by the second sub-wiring shield electrode 83. The shielding performance may be adjusted according to the frequency of noise that is the suppression target for the first wiring 42.

Any of the first openings 33a, the second openings 63a, the third openings 43a, the fourth openings 73a, the fifth openings 53a, and the sixth openings 83a may be set to have a maximum span dimension that differs from at least one other. This allows appropriate shielding performance to be ensured at each position according to the frequency of noise that is the suppression target.

For example, the maximum span dimension of the first openings 33a may be set to differ from at least one of the maximum span dimensions of the second openings 63a, the third openings 43a, the fourth openings 73a, the fifth openings 53a, and the sixth openings 83a. Further, the maximum span dimension of the second openings 63a may be set to differ from at least one of the maximum span dimensions of the first openings 33a, the third openings 43a, the fourth openings 73a, the fifth openings 53a, and the sixth openings 83a.

### Modification

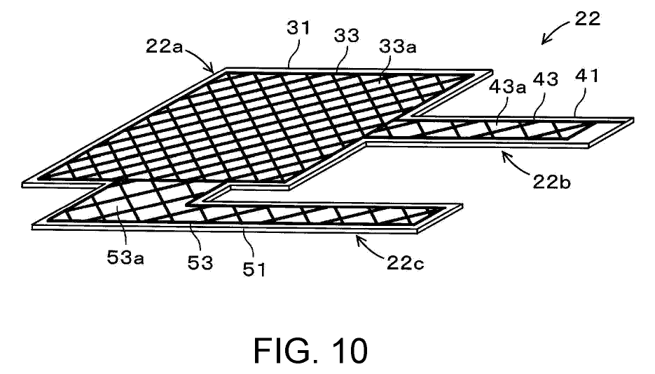

As described above, the first openings 33a, the second openings 63a, the third openings 43a, the fourth openings 73a, the fifth openings 53a, and the sixth openings 83a may be set to any shape and size. For example, as shown in FIG. 10, the first openings 33a may be set to have a smaller maximum span dimension than the third opening 43a and the fifth opening 53a. The same applies to other openings.

What is claimed is:

1. A pressure sensor, comprising:
an insulator sheet body;
a first detection electrode, disposed on a first surface side of the insulator sheet body;
a second detection electrode, disposed on a second surface side of the insulator sheet body and disposed to overlap the first detection electrode;
a first insulator sheet, disposed on an outer surface side of the first detection electrode; and
a first shield electrode, disposed on an outer surface side of the first insulator sheet and electromagnetically shielding the first detection electrode,
wherein the first insulator sheet has a thickness equal to or less than a thickness of the insulator sheet body,
the first shield electrode
is disposed to overlap the first detection electrode when viewed from a thickness direction of the first shield electrode, has an outer shape including an outer shape of the first detection electrode, and
comprises a plurality of first openings penetrating in a thickness direction of the first shield electrode.

2. The pressure sensor according to claim 1, further comprising:
a second insulator sheet, disposed on an outer surface side of the second detection electrode; and
a second shield electrode, disposed on an outer surface side of the second insulator sheet and electromagnetically shielding the second detection electrode,
wherein the second insulator sheet has a thickness equal to or less than a thickness of the insulator sheet body,
wherein the second shield electrode
is disposed to overlap the second detection electrode when viewed from a thickness direction of the second shield electrode, has an outer shape including an outer shape of the second detection electrode, and
comprises a plurality of second openings penetrating in a thickness direction of the second shield electrode.

3. The pressure sensor according to claim 1, further comprising:
a first electrode unit, disposed on a first surface side of the insulator sheet body and configured as a separate body from the insulator sheet body,
wherein the first electrode unit comprises:
the first insulator sheet;
the first detection electrode, adhered to an inner surface of the first insulator sheet and disposed non-adhered to the insulator sheet body; and
the first shield electrode, adhered to an outer surface of the first insulator sheet.

4. The pressure sensor according to claim 3, wherein the first detection electrode is a printed formation adhered to an inner surface of the first insulator sheet, and
the first shield electrode is a printed formation adhered to an outer surface of the first insulator sheet.

5. The pressure sensor according to claim 2, further comprising:
a first electrode unit, disposed on a first surface side of the insulator sheet body and configured as a separate body from the insulator sheet body; and
a second electrode unit, disposed on a second surface side of the insulator sheet body, disposed to overlap the first electrode unit, and configured as a separate body from the insulator sheet body,
wherein the first electrode unit comprises:
the first insulator sheet;
the first detection electrode, adhered to an inner surface of the first insulator sheet and disposed non-adhered to the insulator sheet body; and
the first shield electrode, adhered to an outer surface of the first insulator sheet, and
the second electrode unit comprises:
the second insulator sheet;
the second detection electrode, adhered to an inner surface of the second insulator sheet and disposed non-adhered to the insulator sheet body; and
the second shield electrode, adhered to an outer surface of the second insulator sheet.

6. The pressure sensor according to claim 5, wherein the first detection electrode is a printed formation adhered to an inner surface of the first insulator sheet,
the first shield electrode is a printed formation adhered to an outer surface of the first insulator sheet,
the second detection electrode is a printed formation adhered to an inner surface of the second insulator sheet, and
the second shield electrode is a printed formation adhered to an outer surface of the second insulator sheet.

7. The pressure sensor according to claim 1, further comprising:
a first main extension insulator sheet, extended in a planar direction of the first insulator sheet from a side edge of the first insulator sheet;
a first wiring, disposed on an inner surface side of the first main extension insulator sheet and electrically connected to the first detection electrode; and
a first main wiring shield electrode, disposed on an outer surface side of the first main extension insulator sheet, electrically connected to the first shield electrode, and electromagnetically shielding the first wiring,
wherein the first main wiring shield electrode
is disposed to overlap the first wiring when viewed from a thickness direction of the first main wiring shield electrode, has an outer shape including an outer shape excluding a connector region of the first wiring, and
comprises a plurality of third openings penetrating in a thickness direction of the first main wiring shield electrode.

8. The pressure sensor according to claim 2, further comprising:
a first main extension insulator sheet, extended in a planar direction of the first insulator sheet from a side edge of the first insulator sheet;
a first wiring, disposed on an inner surface side of the first main extension insulator sheet and electrically connected to the first detection electrode; and
a first main wiring shield electrode, disposed on an outer surface side of the first main extension insulator sheet, electrically connected to the first shield electrode, and electromagnetically shielding the first wiring,
wherein the first main wiring shield electrode
is disposed to overlap the first wiring when viewed from a thickness direction of the first main wiring shield electrode, has an outer shape including an outer shape excluding a connector region of the first wiring, and
comprises a plurality of third openings penetrating in a thickness direction of the first main wiring shield electrode,
the pressure sensor further comprising:
a second main extension insulator sheet, extended in a planar direction of the second insulator sheet from a side edge of the second insulator sheet;
a second wiring, disposed on an inner surface side of the second main extension insulator sheet and electrically connected to the second detection electrode; and
a second main wiring shield electrode, disposed on an outer surface side of the second main extension insulator sheet, electrically connected to the second shield electrode, and electromagnetically shielding the second wiring,
wherein the second main wiring shield electrode
is disposed to overlap the second wiring when viewed from a thickness direction of the second main wiring shield electrode, has an outer shape including an outer shape excluding a connector region of the second wiring, and
comprises a plurality of fourth openings penetrating in a thickness direction of the second main wiring shield electrode.

9. The pressure sensor according to claim 8, further comprising:
a first sub-extension insulator sheet, extended in a planar direction of the first insulator sheet from a side edge of the first insulator sheet, disposed non-adhered to the second main extension insulator sheet, and disposed facing the second main extension insulator sheet; and
a first sub-wiring shield electrode, disposed on an outer surface side of the first sub-extension insulator sheet, electrically connected to the first shield electrode, and electromagnetically shielding the second wiring,
wherein the first sub-wiring shield electrode
is disposed to overlap the second wiring when viewed from a thickness direction of the first sub-wiring shield electrode, has an outer shape including an outer shape excluding a connector region of the second wiring, and
comprises a plurality of fifth openings penetrating in a thickness direction of the first sub-wiring shield electrode.

10. The pressure sensor according to claim 9, further comprising:
a second sub-extension insulator sheet, extended in a planar direction of the second insulator sheet from a side edge of the second insulator sheet, disposed non-adhered to the first main extension insulator sheet, and disposed facing the first main extension insulator sheet; and
a second sub-wiring shield electrode, disposed on an outer surface side of the second sub-extension insulator sheet, electrically connected to the second shield electrode, and electromagnetically shielding the first wiring,
wherein the second sub-wiring shield electrode
is disposed to overlap the first wiring when viewed from a thickness direction of the second sub-wiring shield electrode, has an outer shape including an outer shape excluding a connector region of the first wiring, and
comprises a plurality of sixth openings penetrating in a thickness direction of the second sub-wiring shield electrode.

11. The pressure sensor according to claim 1, wherein the insulator sheet body, the first detection electrode, and the second detection electrode are disposed non-adhesively.

12. The pressure sensor according to claim 1, wherein the plurality of first openings have maximum span dimensions set in a plurality of settings according to a frequency of noise that is a target to be electromagnetically shielded by the first shield electrode.

13. The pressure sensor according to claim 2, wherein the plurality of first openings have maximum span dimensions set in a plurality of settings according to a frequency of noise that is a target to be electromagnetically shielded by the first shield electrode, and
maximum span dimensions of the plurality of second openings are set in a plurality of settings according to a frequency of noise that is a target to be electromagnetically shielded by the second shield electrode.

14. The pressure sensor according to claim 7, wherein the plurality of first openings have maximum span dimensions set in a plurality of settings according to a frequency of noise that is a target to be electromagnetically shielded by the first shield electrode, and
maximum span dimensions of the plurality of third openings are set in a plurality of settings according to a frequency of noise that is a target to be electromagnetically shielded by the first main wiring shield electrode.

15. The pressure sensor according to claim 8, wherein the plurality of first openings have maximum span dimensions set in a plurality of settings according to a frequency of noise that is a target to be electromagnetically shielded by the first shield electrode,
maximum span dimensions of the plurality of second openings are set in a plurality of settings according to a frequency of noise that is a target to be electromagnetically shielded by the second shield electrode,
maximum span dimensions of the plurality of third openings are set in a plurality of settings according to a frequency of noise that is a target to be electromagnetically shielded by the first main wiring shield electrode, and
maximum span dimensions of the plurality of fourth openings are set in a plurality of settings according to a frequency of noise that is a target to be electromagnetically shielded by the second main wiring shield electrode.

16. The pressure sensor according to claim 10, wherein the first openings have a maximum span dimension different from at least one of maximum span dimensions of the second openings, the third openings, the fourth openings, the fifth openings, and the sixth openings.

17. The pressure sensor according to claim 10, wherein the second openings have a maximum span dimension different from at least one of maximum span dimensions of the first openings, the third openings, the fourth openings, the fifth openings, and the sixth openings.

18. A pressure sensor, comprising:
an insulator sheet body;
a first electrode unit, disposed on a first surface side of the insulator sheet body, disposed non-adhered to the insulator sheet body, and configured as a separate body from the insulator sheet body; and
a second detection electrode, disposed on a second surface side of the insulator sheet body, disposed non-adhered to the insulator sheet body, and disposed to overlap the first electrode unit,
wherein the first electrode unit comprises:
a first insulator sheet;
a first detection electrode, adhered to an inner surface of the first insulator sheet; and
a first shield electrode, adhered to an outer surface of the first insulator sheet and electromagnetically shielding the first detection electrode.

19. The pressure sensor according to claim 18, further comprising:
a second electrode unit, disposed on a second surface side of the insulator sheet body, disposed to overlap the first electrode unit, and configured as a separate body from the insulator sheet body,
wherein the second electrode unit comprises:
a second insulator sheet;
a second detection electrode, adhered to an inner surface of the second insulator sheet; and
a second shield electrode, adhered to an outer surface of the second insulator sheet and electromagnetically shielding the second detection electrode.

20. The pressure sensor according to claim 18, wherein the first detection electrode is a printed formation adhered to an inner surface of the first insulator sheet, and
the first shield electrode is a printed formation adhered to an outer surface of the first insulator sheet.

21. The pressure sensor according to claim 19, wherein the first detection electrode is a printed formation adhered to an inner surface of the first insulator sheet,
the first shield electrode is a printed formation adhered to an outer surface of the first insulator sheet,
the second detection electrode is a printed formation adhered to an inner surface of the second insulator sheet, and
the second shield electrode is a printed formation adhered to an outer surface of the second insulator sheet.
